(19) United States
(12) Patent Application Publication
(10) Pub. No.: US 2007/0061425 A1
(43) Pub. Date: Mar. 15, 2007

(54) Bulletin board system, server for bulletin board system, thread display method for client of bulletin board system, and program

(75) Inventors: Hiroshi Yamamoto, Kyoto (JP); Kiyotaka Kasubuchi, Kyoto (JP); Kazuya Hamaguchi, Osaka (JP)

Correspondence Address: MCDERMOTT WILL & EMERY LLP, 600 13TH STREET, N.W., WASHINGTON, DC, 20005-3096, US

(73) Assignee: DAINIPPON SCREEN MFG. CO., LTD.

(21) Appl. No.: 11/500,364

(22) Filed: Aug. 8, 2006

(30) Foreign Application Priority Data
Aug. 26, 2005 (JP) JP2005-246001

(51) Int. Cl. G06F 15/16

(52) U.S. Cl. 709/219

(57) ABSTRACT

When a new theme is proposed and a thread is created, a category applicable to the thread is specified. In a menu, the theme and the category are displayed together. The thread is displayed in a form in accordance with the specified category. By specifying the category in accordance with the proposed theme, it is possible to suppress the divergence of comment details made on the thread in advance and limit the direction of comments. Further, on the thread, it becomes easy to display the contents proper for the nature of the proposed theme and efficiently perform an output display. This allows more efficient decision making and information sharing by using a bulletin board system. With this operation, it is possible to provide a bulletin board system in which the direction of comments can be limited in accordance with the category of the theme, such as discussion or question, and a summary of conclusion based on the comment details and an output in accordance with the theme can be efficiently performed.

### BACKGROUND OF THE INVENTION

1. Field of the Invention

The present invention relates to a bulletin board system used on a computer network.

2. Description of the Background Art

On a computer network such as an internet or an intranet constructed inside a company, an (electronic) bulletin board system (hereinafter, sometimes referred to simply as an “electronic bulletin board”) is widely used as a tool for information sharing, conversation, discussion and the like.

There are various styles of electronic bulletin boards. In a simplest one, when a user accesses a server computer of a bulletin board system from a computer (client) connected to a network, comments which have been already contributed and a form through which a new contribution (comment) should be made are displayed together on the client, and when the user writes in the form and clicks a send button, the detail which is written is added to the system as a contributed comment. In this case, the contributed comments are displayed basically in time series order.

As a general-type one used is an electronic bulletin board which has a thread structure where a response to the already-made comment can be made with the comment (parent comment) selected. Also in this case, display of comments in each thread is performed basically in time series order.

In a case where the electronic bulletin board with time series display is used for discussion, however, as participants increases or more comments and responses are repeatedly made, correspondence between one opinion and others tends to become indefinite. A bulletin board system to solve this problem is well known, where if a proposition is given, contribution details relevant to this proposition are displayed, being grouped by standpoints (attributes) of the comments, to make the correspondence between one opinion and others definite (for example, disclosed in Japanese Patent Application Laid Open Gazette No. 2003-76639).

In the conventional electronic bulletin board, not limited to the case where discussion is made on a proposition to come to some conclusion, such as discussed in Japanese Patent Application Laid Open Gazette No. 2003-76639, but also in a case where some answer is sought on a question or a problem, there likely arises a problem that details of comments should diverge to thereby make the correspondence between the question and the comments indefinite and make the discussion incoherent. Normally, there is an administrator for a bulletin board system, and apart from a case where the administrator forcedly delete obscene comments, it is not always general that the administrator judges whether the direction of each comment detail conforms to the proposition or the purpose of question or not or suppress divergence or disorder of comment details and it is difficult for the administrator to actually do that. The bulletin board system is apt to cause comments to flow in without check. Particularly, an open electronic bulletin board in which an indefinite number of persons can take part and have anonymity is more likely to fall into such a condition.

On the other hand, in not a few cases, the electronic bulletin board is used as a tool for decision making and information sharing in a company or a closed group. In this case, decision making refers to an activity where discussion is made on a proposition to come to a conclusion for this proposition in the electronic bulletin board. Information sharing is achieved by making comments which are to become useful answers for a question made in the electronic bulletin board. In such cases, since the electronic bulletin board is usually shared among members of a closed group having a certain range, it is relatively easy for the administrator to take flexible steps such as suggestion to correct the direction of comment but there may still arise such divergence or disorder of comments as discussed above. Therefore, in order to effectively play its role, it is preferable for the electronic bulletin board to have a system configuration to suppress such a condition. Besides, since such decision making and information sharing require speed and clarity in many cases, it is preferable to easily sum up a conclusion based on comment details. The conventional electronic bulletin board, however, does not have such a function.

### SUMMARY OF THE INVENTION

The present invention is intended for a bulletin board system used on a computer network.

According to the present invention, the bulletin board system comprises a) a server computer and b) at least one client computer provided, being capable of accessing the server computer through a network. The server computer comprises a-1) a thread creation element for providing a predetermined thread creation menu to the at least one client computer to create a thread in response to a creation request based on the thread creation menu, a-2) a category specification element for providing a predetermined category specification menu to the at least one client computer to specify one out of a plurality of predetermined categories on the thread created by the thread creation element in response to a predetermined specification request based on the category specification menu, a-3) a comment operation element for enabling a comment from the at least one client computer on a comment object thread in response to a predetermined comment request from the client computer, a-4) a storage element for storing a detail of the thread created by the thread creation element and a detail of the comment on the thread which is given by the at least one client computer, along with information of a category specified on the thread, in a predetermined database, a-5) a form memory element for storing a plurality of display forms corresponding to a plurality of categories which can be specified by the category specification element, and a-6) a display element for acquiring a display form of a display object thread from the form memory element in response to a predetermined display request from the at least one client computer and putting a display detail of the display object thread acquired from the database into the display form, thereby implementing of displaying the display object thread in the client computer, and in the bulletin board system of the present invention, the comment object thread is selected out of one or more threads created in the thread creation element, by a client computer which makes the comment request, the display object thread is selected out of one or more threads created in the thread creation element, by a client computer which makes the display request, and the acquisition of the display form in the display element is performed on the basis of a category specified by the category specification element on the display object thread.

With this constitution, when a thread is created on an electronic bulletin board with a new theme begin proposed, a category applicable to the thread is specified, and the thread is displayed in accordance with the specified category. By specifying the category in accordance with the theme proposed in the thread, it is possible to suppress the divergence of comment details to be made on the thread in advance to limit the direction of comments and easily display the details proper for the nature of the proposed theme on the thread. This allows more efficient decision making and information sharing by using the bulletin board system.

Preferably, the bulletin board system further comprises a-8) a conclusion edit element for enabling a conclusion edit on a thread being displayed in response to a conclusion edit request from one of the at least one client computer, and in the bulletin board system of the present invention, the thread being displayed is at least one thread created in the thread creation element, which is displayed by one of the at least one client computer, and at least one comment detail included in the thread is selected to be edited in the conclusion edit.

With this, it is possible to efficiently sum up the conclusion by summing up and sorting out the comment details made on the thread.

Preferably, in the bulletin board system, the comment operation element comprises a-3-1) an attribute giving element operating to allow the at least one client computer to give an attribute to a comment when the comment is made from the at least one client computer.

With this, it is possible to concisely express the standpoint of a commenter on the theme by the attribute when a comment is made on the theme proposed in the thread, and to easily sort out and sum up the details on the thread. When a statistical operation is performed on the comments, the attribute can be used as an index for this operation.

Therefore, it is an object of the present invention to provide a bulletin board system which can limit the direction of comments in accordance with a category of a theme such as discussion or question and efficiently sum up a conclusion on the basis of the comment details.

These and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view schematically showing a structure of a bulletin board system in accordance with a preferred embodiment of the present invention;

FIG. 2 is a view showing constituent elements to implement various functions of the electronic bulletin board;

FIG. 3 is a view showing an exemplary main menu of the electronic bulletin board, which is displayed on a browser of a client computer;

FIG. 4 is a view showing an operation flow for display of the main menu;

FIG. 5 is a view showing an exemplary list of item names and XML tags for describing contents of the items in each of records stored in a bulletin board database;

FIG. 6 is a view showing an operation flow for creation of a new theme;

FIG. 7 is a view an exemplary new theme creation menu of the electronic bulletin board, which is displayed on the browser of the client computer;

FIG. 8 is a view showing an operation flow for display of a thread;

FIG. 9 is a view showing an exemplary question thread screen which is a thread screen on a theme of “Question” category;

FIG. 10 is a view showing an exemplary discussion thread screen which is a thread screen on a theme of “Discussion” category;

FIG. 11 is a view showing an XML script to realize the thread screen;

FIG. 12 is a view showing an operation flow on a new comment;

FIG. 13 is a view showing an operation flow on conclusion edit;

FIG. 14 is a view showing an operation flow on output;

FIG. 15 is a view showing an exemplary question output setting menu which is an output setting menu on the theme of “Question” category;

FIG. 16 is a view showing an exemplary discussion output setting menu which is an output setting menu on the theme of “Discussion” category;

FIG. 17 is a view showing an exemplary output result on the theme of “Question” category; and

FIG. 18 is a view showing an exemplary output result on the theme of “Discussion” category.

### DESCRIPTION OF THE PREFERRED EMBODIMENTS

<System Outline>

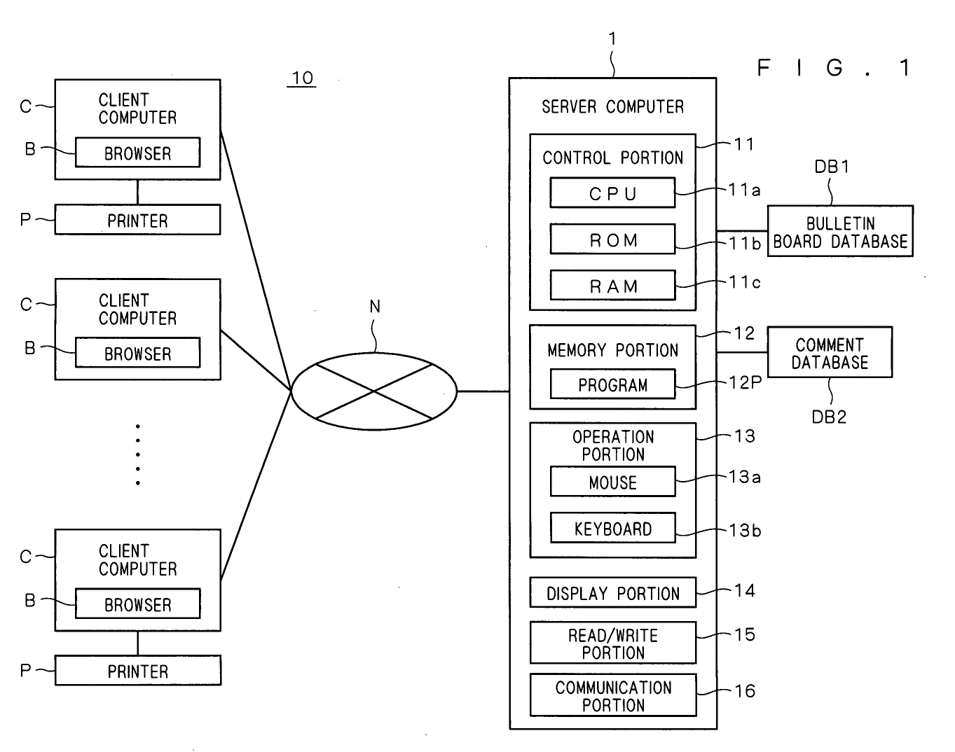

FIG. 1 is a view schematically showing a structure of a bulletin board system 10 in accordance with a preferred embodiment of the present invention. The bulletin board system 10 mainly comprises a server computer 1 and a plurality of client computers C capable of accessing the server computer 1 through a network N such as an internet or an intranet. The bulletin board system 10 is a system to realize display of an electronic bulletin board in each client computer C and writing to the electronic bulletin board. Use of the electronic bulletin board allows exchange of opinions or information sharing among respective users of the client computers.

The server computer 1 serves as a web server, which can execute a program 12p to achieve display of an electronic bulletin board in each client computer C and writing to the electronic bulletin board from each client computer C and store written details into a predetermined database.

The server computer 1 mainly comprises a control portion 11 which is constituted of a CPU 11a, a ROM 11b and a RAM 11c to implement later-described functions, a memory portion 12 which is constituted of a hard disk and the like to store the program 12p and other programs and various data, and a communication portion 16 serving as a network interface. In addition, the server computer 1 may comprise an operation portion 13 consisting of a mouse 13a, a keyboard 13b and the like for input operation, a display portion 14 such as a display and a read/write portion 15 for performing read/write of data with various portable recording media such as MO, CD-R or DVD-RAM.

To the server computer 1 connected to two types of databases for storing details written to the electronic bulletin board from each client computer C. One of them is a bulletin board database DB1 and the other is a comment database DB2. These databases are each constructed as a relational database (RDB). Detailed description of these will be made later. It is not always necessary, however, to physically separate the bulletin board database DB1 and the comment database DB2, and for example, these databases may be constructed in a database server. Alternatively, these databases may be included inside the server computer 1.

The client computer C is a consumer personal computer which is widely used in general. Alternatively, instead of the client computer C, a terminal for exclusive use of the bulletin board system may be used. In the client computer C, a not-shown program is executed on an operating system to start an operation of a browser B capable of displaying an electronic bulletin board on a not-shown display. With the browser B set in motion, when a predetermined operation request to display the electronic bulletin board is sent to the server computer 1 (for example, the URL of a main menu of the electronic bulletin board is sent thereto), the server computer 1 receiving the operation request returns data in accordance with the detail which is sent and the browser B performs display in accordance with the detail which is returned. If writing is made, when a content written in a predetermined writing field is sent to the server computer 1, the server computer 1, receiving this content, returns data for display which reflects the writing and the browser B performs display based on the data, to thereby achieve a state where a new writing is made in the electronic bulletin board.

The client computer C may comprise a printer P. In this case, it is possible to output the written detail on printing paper in accordance with a predetermined setting.

Though three client computers C are shown in FIG. 1, the number of client computers is not limited to this.

<Functional Structure of Bulletin Board System>

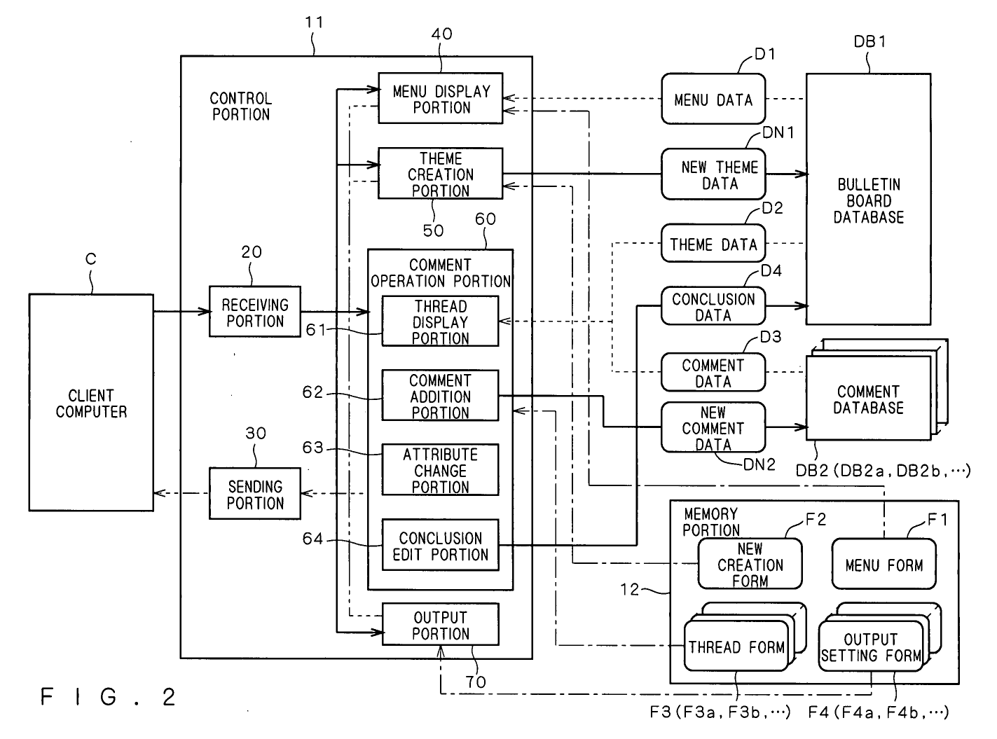

FIG. 2 is a view showing constituent elements to implement various functions of the electronic bulletin board. In the control portion 11 of the server computer 1, the predetermined program 12p (FIG. 1) stored in the memory portion 12 is executed to mainly implement a receiving portion 20, a sending portion 30, a menu display portion 40, a theme creation portion 50, a comment operation portion 60 and an output portion 70 as shown in FIG. 2, through actions of the CPU 11a, the ROM 11b and the RAM 11c.

The memory portion 12 stores several form data to realize screens appearing on the browser B when the client computer C uses the electronic bulletin board. These are data described in a description format which can be displayed on the browser B. For example, these are data described in an XML format. Specifically, the memory portion 12 stores a menu form F1 for display of a main menu for the electronic bulletin board, a new creation form F2 for display of a creation menu for creating a new theme, a thread form F3 for display of a thread on a theme and an output setting form F4 for display of an output setting menu for performing an output with the printer P. With respect to each of the menu form F1 and the new creation form F2, one type is stored, and with respect to each of the thread form F3 and the output setting form F4, a plurality of types are stored in accordance with categories of theme as discussed later.

The bulletin board database DB1 is a database for management of themes (propositions for discussion or questions) written in the electronic bulletin board. In the bulletin board system 10 of the present preferred embodiment, each time when a new theme is provided from any one client computer C, one unit record containing several items such as a detail of the theme and a proposer is stored in the bulletin board database DB1. Specifically, one theme is managed by one identification number. The contents (details) of the records stored in the bulletin board database DB1 are used for display of a menu in the main menu MM and display of a header part in displaying a thread as discussed later.

The comment database DB2 is a database for management of comments written for a theme. In the bulletin board system 10 of the present preferred embodiment, each time when a new comment is made on each theme from any one client computer C, one unit record containing several items such as a detail of the comment and a commenter is stored in the comment database DB2, being associated with the theme (exactly, its identification number). Specifically, one comment is managed by one identification number. With respect to the comment database DB2, a plurality of comment databases DB2a, DB2b . . . are constructed in accordance with later-discussed categories. The contents (details) of the records stored in the comment database DB2 are used for display of a thread.

In the bulletin board system 10 of the present preferred embodiment, a thread-type electronic bulletin board is realized, where discussions and answers can be made in parallel for a plurality of themes. Specifically, when a client computer C accesses the electronic bulletin board, a main menu is displayed, and in the main menu, themes which have been already proposed are displayed, being listed, on the basis of the contents stored in the bulletin board database DB1. In other words, each theme corresponds to one thread. Then, when one theme is selected, only comments made for the theme are displayed. In other words, only the comments made in a thread on the theme are displayed. These display operations are realized by reading the records stored in the bulletin board database DB1 and the comment database DB2 out as appropriate in accordance with the selection.

The receiving portion 20 interprets a predetermined operation request sent from the client computer C through the network N and requests the above constituent elements to perform operations in accordance with the content of the operation request.

The sending portion 30 responds to the operation request from the client computer C and sends data provided from the other constituent elements to the client computer C.

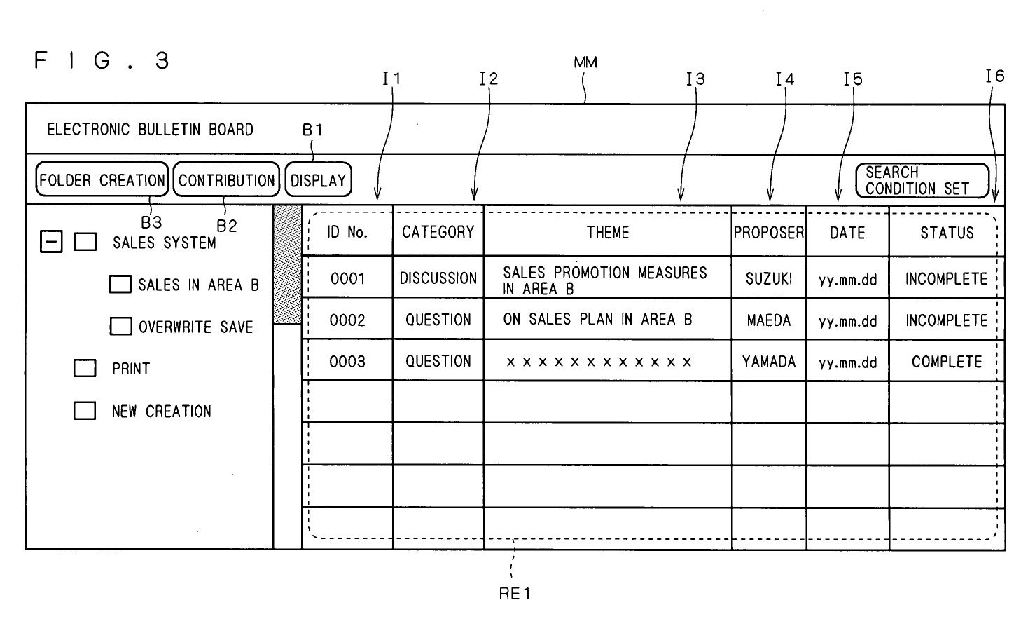

The menu display portion 40 performs an operation necessary to display the main menu of the electronic bulletin board in the client computer C. FIG. 3 is a view showing an exemplary main menu MM of the electronic bulletin board, which is displayed on the browser B of the client computer C. The main menu MM is provided with a layout of the menu form F1 and achieved by putting some of contents of the records stored in the bulletin board database DB1 in a display region RE1 surrounded by broken line in FIG. 3.

In the display region RE1, in the item I1 with item name “ID No.” an identification number for uniquely identifying each theme (i.e., each thread) in the bulletin board database DB1 is displayed. In FIG. 3, three themes with their identification numbers 0001, 0002 and 0003 are already displayed in the main menu MM of the electronic bulletin board, and this means that data on these three themes are stored in the bulletin board database DB1.

In the item 12 with item name “CATEGORY”, the category to which each thread belongs (thread attribute) is displayed. The category is used for identifying the content type of each thread and includes “QUESTION”, “DISCUSSION” and the like. Such specification of the category is considered to produce an effect of limiting details of comments which should be made on the theme provided in each thread. In other words, it is considered to produce an effect of avoiding divergence of comments out from the content of the theme. Further, in the bulletin board system 10 of the present preferred embodiment, not to limited to this, the thread form F3 and the output setting form F4 are provided in accordance with the type of category as discussed later and it is characteristic that the inherent operation proper for each category can be performed. For example, it is possible to effectively derive a final conclusion on a question or a discussion or perform an output in accordance with the category.

In a case where a question is proposed as a theme, for example, it is preferable that a plurality of comments should be given as answers for this question to finally derive an optimum conclusion from these comments. Therefore, it is not necessarily essential to ask the pros and cons of this question. In contrast to this, in a case where a proposition is proposed as a theme, required is indication of approval or disapproval and its reason from a plurality of persons. In this situation, there are some cases where approval or disapproval for the proposition is essentially important and other cases where it is important to sum opinions from both standpoints but it is not necessarily required to derive one conclusion, in other words, where a conclusion with approval and disapproval on one proposition may be derived.

Thus, it is general that details of comments to be required are different in accordance with themes provided in threads. In the bulletin board system 10 of the present preferred embodiment, by specifying a category on the proposed theme and causing the thread on the theme to develop with a form in accordance with the specified category, it is possible to encourage exclusion of not-constructive comments and efficient acquisition of a conclusion.

In the items 13, 14, 15 and 16 with respective item names “THEME”, “PROPOSER”, “DATE” and “STATUS”, the title of each theme, the name of person who proposes the theme, the date when the theme is proposed and the status of the thread on the theme (discussed later) are displayed, respectively.

A display button B1 is used to select a thread to be displayed. When a user of the client computer C selects any one of the identification numbers by clicking its position with a not-shown mouse, and so on, on a screen where the main menu MM is displayed on the browser B and further selects the display button B1, the thread on the theme will be displayed. When a contribution button B2 is selected, a new theme creation menu MN described next will be displayed. A folder creation button B3 is used to group the threads by folders for management.

The theme creation portion 50 performs an operation for proposing a new theme (creating a new thread) in the electronic bulletin board. Specification of the category on the theme is performed in this timing of proposition. The operation for creating a new theme, using the new theme creation menu, will be discussed later.

The comment operation portion 60 performs operations for displaying the detail of each thread in the client computer C and making a comment on the thread. In other words, the comment operation portion 60 performs an operation necessary to deal with the thread for the theme on the browser B. The comment operation portion 60 mainly comprises a thread display portion 61, a comment addition portion 62, an attribute change portion 63 and a conclusion edit portion 64. Respective actions and processings of these constituent elements will be discussed later.

The output portion 70 performs an operation necessary to output the contents of the thread displayed in the electronic bulletin board. In the bulletin board system 10 of the present preferred embodiment, an output setting menu in accordance with the type of category is prepared as the output setting form F4 in order to perform an output of the contents of each thread in accordance with the category. Depending on the output setting menu, it is possible to perform a statistical operation based on the records stored in the comment database DB2 and perform an output along with the result. Detailed discussion on the output operation will be made later.

<Display of Main Menu>

Hereinafter, the operations performed in the bulletin board system 10 will be sequentially discussed. First, the operation for display of the main menu MM, serving as an entrance of the electronic bulletin board realized by the bulletin board system 10, will be discussed.

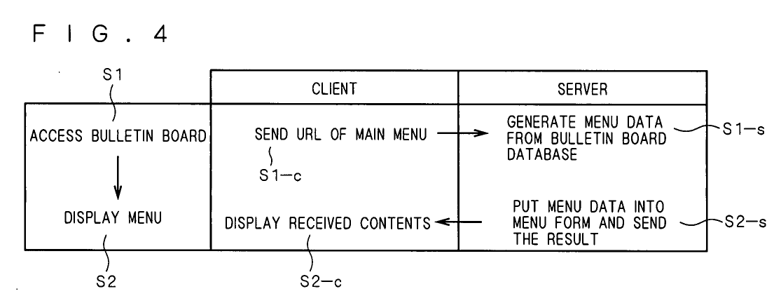

FIG. 4 is a view showing an operation flow for display of the main menu. When a user of the client computer C accesses the electronic bulletin board from the client computer C (Step S1), the user sends the URL of the main menu MM shown in FIG. 3 to the server computer 1 from the client computer C (Step S1-c).

In the server computer 1, the receiving portion 20 receives the URL through the communication portion 16. The receiving portion 20 interprets the received URL as one relevant to the main menu MM and gives a request for an operation of displaying the main menu to the menu display portion 40. Then, the menu display portion 40 responds to this request, and first generates menu data D1 necessary to display the main menu from the bulletin board database DB1 (Step S1-s). The menu data D1 is data obtained by extracting from the bulletin board database DB1 the contents for the items I1 to I6 to be displayed in the display region RE1 of the main menu.

The menu data D1 generated thus is put into the menu form F1 read out from the memory portion 12 and the composite data is sent to the client computer C from the sending portion 30 (Step S2-s). The client computer C displays the received contents (Step S2-c), to thereby achieve the display of the main menu MM as shown in FIG. 3 in the client computer C (Step S2).

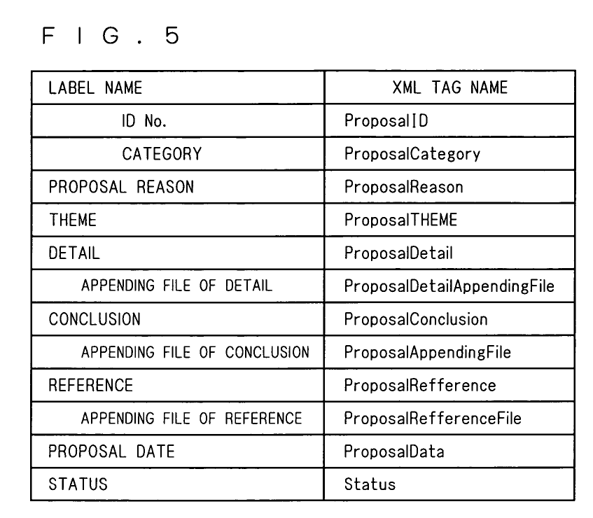

If the menu form F1 is described in an XML format, positions to which the contents of the menu data D1 should be described (put) are reserved in advance by using XML tags in an XML script of the menu form F1. FIG. 5 is a view showing an exemplary list of item names (label names in FIG. 5) and XML tags (XML tag names in FIG. 5) for describing the contents of the items in each of the records stored in the bulletin board database DB1. This correspondence is also described in the bulletin board database DB1. In such a case, when the menu is displayed, the respective contents of the items are put in the positions in which the corresponding XML tags are described in the menu form F1.

The contents stored in the bulletin board database DB1 can be frequently rewritten. In other words, the contents to be described as the menu data D1 are changed. Therefore, the menu display portion 40 generates the menu data D1 on the basis of the bulletin board database DB1 each time when it receives the request for the operation to display the main menu MM. With this operation, each time when the display of the main menu MM is requested, the latest contents are always displayed.

<Creation of New Theme>

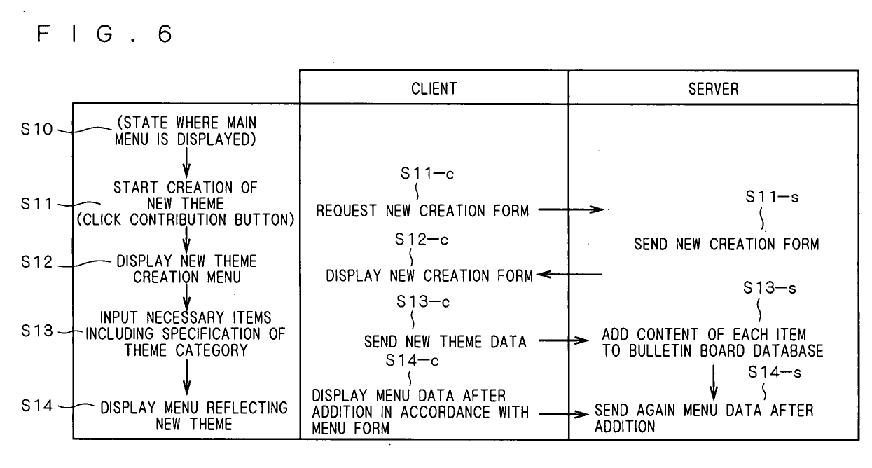

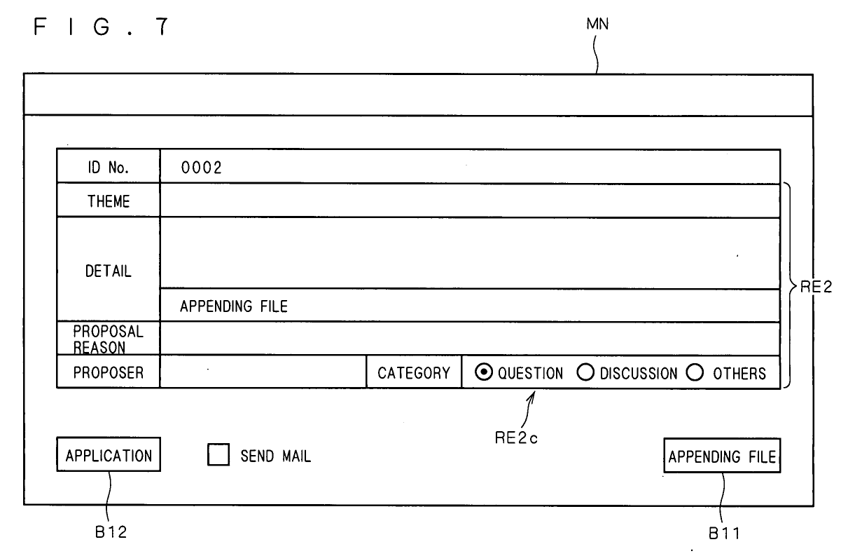

Next, an operation in proposing a new theme (creating a new thread) on the electronic bulletin board will be discussed. FIG. 6 is a view showing an operation flow for creating a new theme. FIG. 7 is a view an exemplary new theme creation menu MN of the electronic bulletin board, which is displayed on the browser B of the client computer C.

In a state where the main menu MM is displayed on the browser B through the procedure shown in FIG. 4 (Step S10), when the user selects the contribution button B2 by clicking or the like, an instruction for starting the new theme creation is given (Step S11). In response to the selection of the contribution button B2, the URL of the new creation form F2 which provides the layout for displaying the new theme creation menu MN on the browser B is sent to the server computer 1 from the client computer C (Step S11-c).

In the server computer 1, the receiving portion 20, receiving the URL, interprets the URL as one relevant to the new theme creation menu and gives a request for an operation of creating a new theme to the theme creation portion 50. The theme creation portion 50 responds to this request, and reads the new creation form F2 out from the memory portion 12. The new creation form F2 is sent to the client computer C by the sending portion 30, and the client computer C displays the received contents (Step S12-c), to thereby achieve the display of the new theme creation menu MN in the client computer C (Step S12).

In the new theme creation menu MN of FIG. 7, inputs for the respective items in an input region RE2 can be accepted. In a category selection region RE2c, it is possible to selectively specify the category of the thread to be created. In accordance with the selected category, the thread form F3 and the output setting form F4 are specified to be used on the thread. Further, it is also possible to select an appending file button B11 and display a not-shown file selection menu to append a file used as a reference on the theme to be proposed. Though only three categories “QUESTION”, “DISCUSSION” and “OTHERS” can be specified in FIG. 7, there may be a case where more categories other than those can be specified. Further, though FIG. 7 shows an exemplary manner of selection using a radio button, other manners may be used for selection.

When the user of the client computer C inputs contents of the necessary items including specification of the category and selects an application button B12 (Step S13), the inputted contents are sent to the server computer 1 as new theme data DN1 (Step S13-c). The receiving portion 20, receiving this data, interprets the new theme data DN1 as data relevant to creation of a new theme and gives a request therefor to the theme creation portion 50. Then, the theme creation portion 50 gives the new theme data DN1 to the bulletin board database DB1. In the bulletin board database DB1, a new record based on the new theme data DN1 is generated and stored therein. In other words, the contents of the items on the new thread are added to the bulletin board database DB1 (Step S13-s).

Such addition means an update of the contents of the menu data D1, and then the menu display portion 40, in response to this, puts the menu data D1 after addition in the menu form F1 and sends the composite form to the client computer C again (Step S14-s). The client computer C displays the received contents (Step S14-c), to thereby achieve the display of the main menu MM reflecting the newly added theme in the list, i.e., the update of the main menu (Step S14).

<Display of Thread>

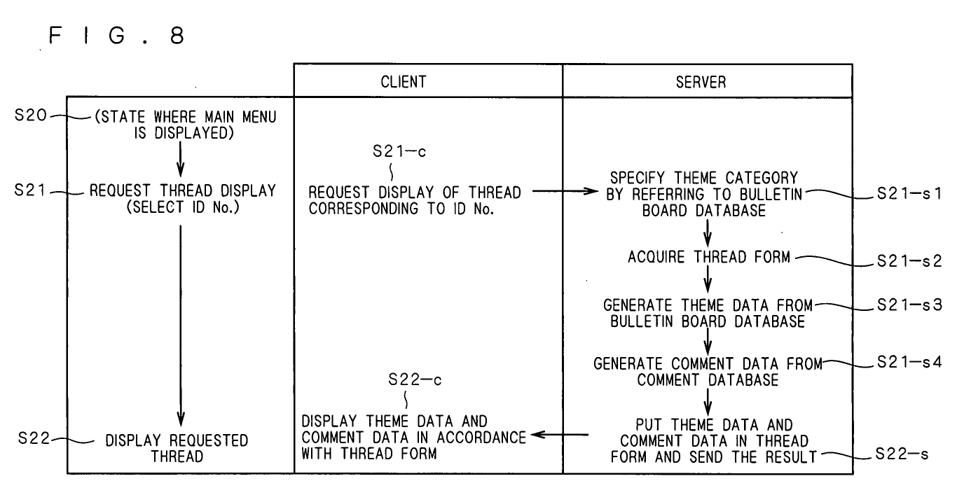

Next, an operation for displaying comments which have been already made on the thread for a theme, i.e., an operation for displaying the contents of the thread will be discussed. FIG. 8 is a view showing an operation flow for display of a thread. The operation for displaying a thread is mainly performed by the action of the thread display portion 61.

In a state where the main menu MM is displayed on the browser B through the procedure shown in FIG. 4 (Step S20), when the user selects one of the themes in the list, on which the thread is to be displayed, by clicking or the like (Step S21), in response to this, the URL of the electronic bulletin board which is associated with the identification number of the theme is sent to the server computer 1 from the client computer C. This corresponds to a display request for the thread to the server computer 1 from the client computer C (Step S21-c).

In the server computer 1, the receiving portion 20, receiving the URL, interprets the URL as one relevant to display of the thread and gives a request for an operation of displaying the thread to the thread display portion 61. The thread display portion 61 responds to this request, and first specifies the category which is specified for the selected theme on the basis of the identification number by referring to the bulletin board database DB1 (Step S21-s1) and acquires the thread form F3 (F3a, F3b . . . ) corresponding to the category from the memory portion 12 (Step S21-s2). Further, the thread display portion 61 acquires the record on the thread from the bulletin board database DB1 as theme data D2 (Step S21-s3) and the record of the comment made on the thread from the comment database DB2 (DB2a, DB2b . . . ) as comment data D3 (Step S21-s4). Then, the theme data D2 and the comment data D3 are put into the thread form F3 and the composite data is sent to the client computer C from the sending portion 30 (Step S22-s). The client computer C displays the received contents (Step S22-c), to thereby achieve the display of the thread in accordance with the contents in the client computer C (Step S22).

With this operation, the contents of the thread are displayed in accordance with the category. In other words, in accordance with respective categories specified for threads, thread screens having different layouts and functions are displayed. In each thread screen which is displayed, a comment which conforms to the characteristics of the category is encouraged.

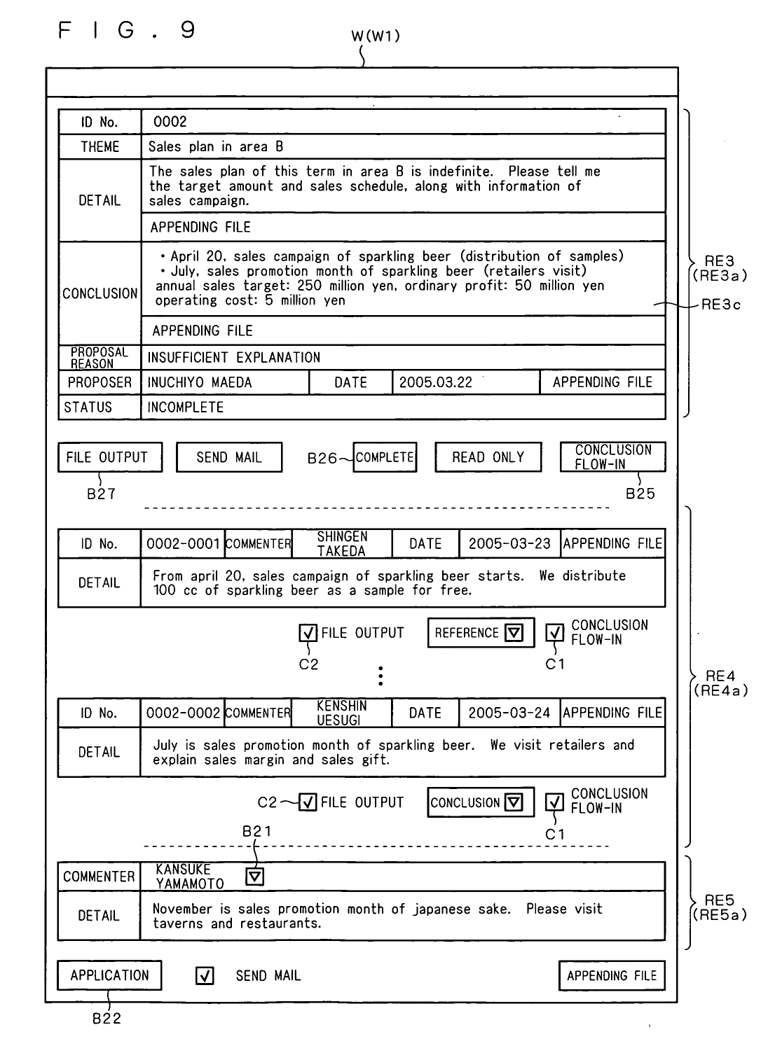

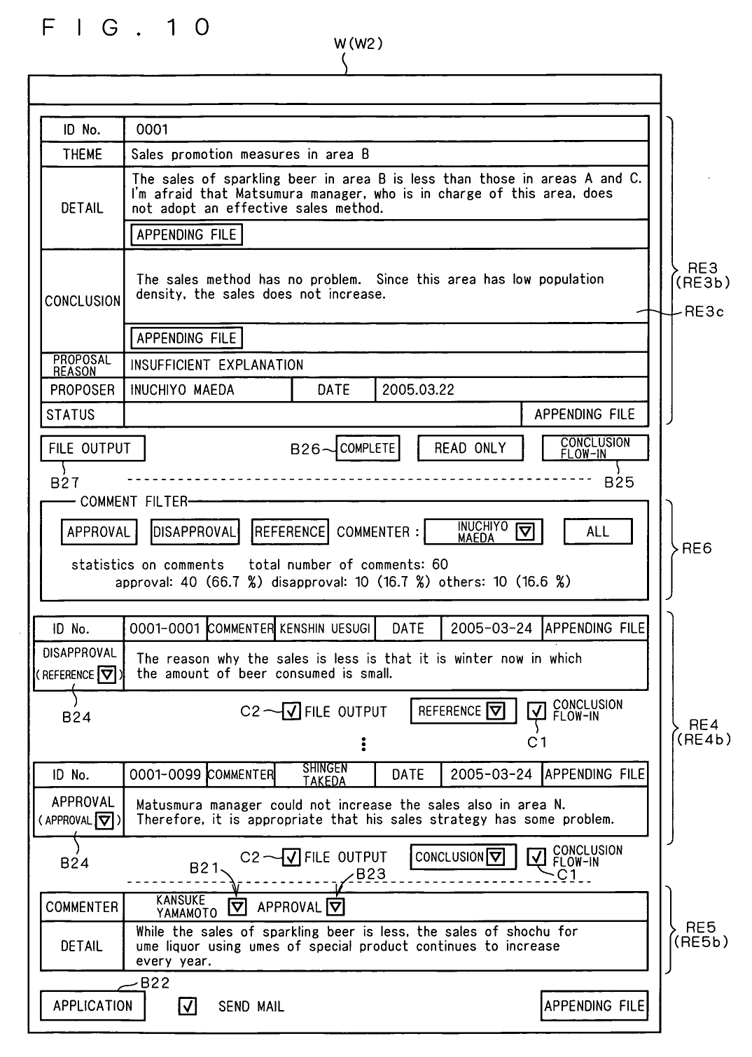

For example, FIG. 9 is a view showing an exemplary question thread screen W1 which is a thread screen W on a theme of “Question” category. FIG. 10 is a view showing an exemplary discussion thread screen W2 which is a thread screen W on a theme of “Discussion” category. The former has a layout in accordance with a question thread form F3a and the latter has a layout in accordance with a discussion thread form F3b.

The question thread screen W1 mainly consists of three regions, i.e., a theme region RE3 (RE3a) where the detail of the theme, a conclusion edited by the administrator at a timing (the edit of conclusion will be discussed later) and the like, acquired from the bulletin board database DB1, are displayed, a comment display region RE4 (RE4a) where the details of comments which have been already made at the time when the question thread screen W1 is open are displayed and a new comment region RE5 (RE5a) which is used when a new comment is made. The discussion thread screen W2 also comprises the theme region RE3 (RE3b), the comment display region RE4 (RE4b) and the new comment region RE5 (RE5b). The theme region RE3 (RE3a, RE3b) is a region where the contents described in the theme data D2 are displayed and the comment display region RE4 (RE4a, RE4b) is a region where the contents described in the comment data D3 are displayed.

The discussion thread screen W2 is, however, different from the question thread screen W1 in that it is further provided with a comment filter region RE6 for filtering the display into the comment display region RE4b of the comments which have been already made on the thread by whether approval or disapproval on the theme proposed in the thread. Other than that, also in the comment display region RE4 and the new comment region RE5, there are differences between the question thread screen W1 and the discussion thread screen W2. These differences are based on constructions of the thread screens W using different thread forms F3 in accordance with the different purposes of the “QUESTION” category and the “DISCUSSION” category. While the “QUESTION” category requires an appropriate answer for the theme, the “DISCUSSION” category ultimately requires the indication of approval or disapproval on the proposition which is proposed as the theme. Because of this difference, the discussion thread screen W2 has a construction where such an indication of approval or disapproval is made in making the comment.

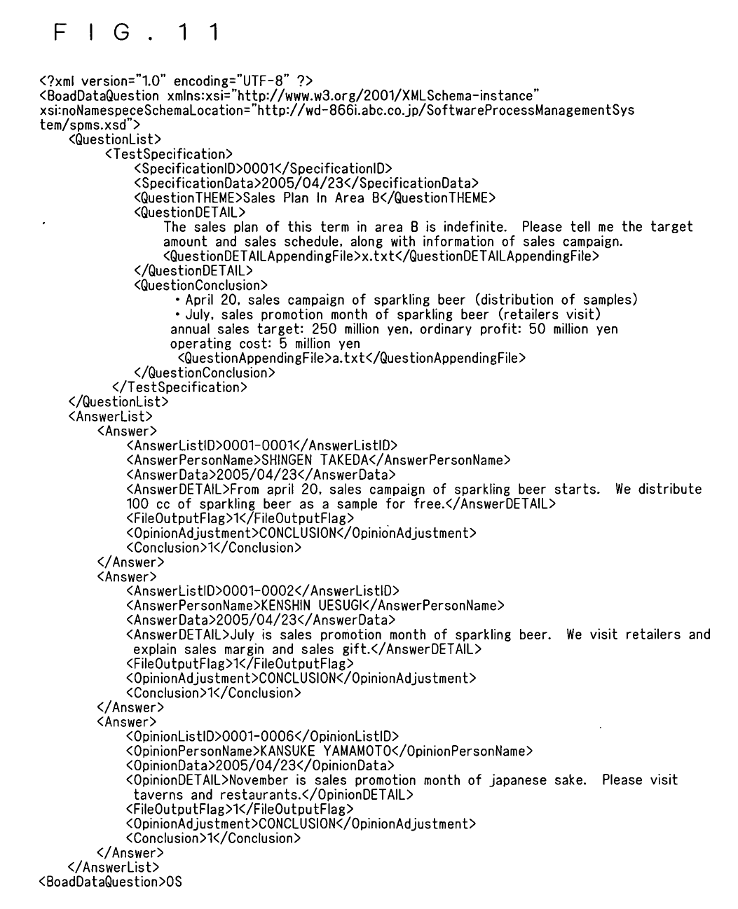

If the thread form F3 is described in an XML format, naturally, these thread screens W are each described in the XML format. FIG. 11 is a view showing the XML script to realize the thread screen W1 shown in FIG. 9.

The contents stored in the comment database DB2 are rewritten each time when the comment is made. In other words, the contents which should be described as the comment data D3 also change (usually increase). Therefore, the thread display portion 61 generates the comment data D3 based on the comment database DB2 each time when it receives the request for the operation of displaying the thread screen W. With this operation, each time when the display of the thread screen W is requested, the latest contents are displayed.

<New Comment>

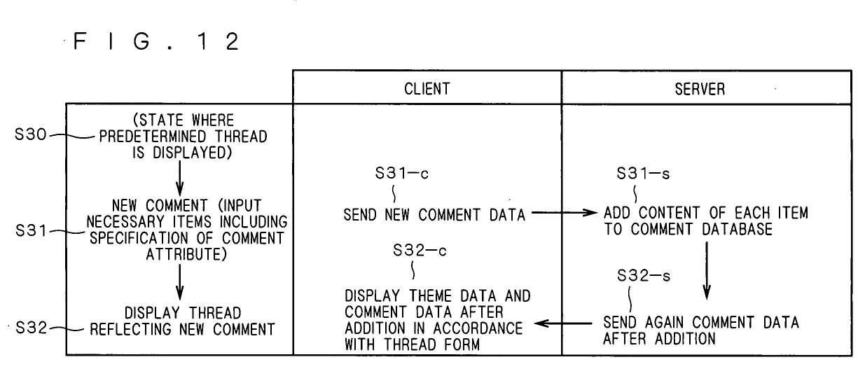

Next, an operation in making a new comment for a thread on a theme will be discussed. FIG. 12 is a view showing an operation flow on a new comment. Such an operation is performed by the action of the comment addition portion 62.

For example, in a state where the thread screen W shown in FIG. 9 or 10, i.e., a thread on a theme is displayed on the browser B (Step S30), inputs for the respective items in the new comment region RE5 can be performed by the client computer C. This is because the description to implement the function relevant to the thread form F3 has been made in advance. Therefore, when a new comment is made, first, it is necessary to input the detail of the comment and others into the respective items (Step S31). Both FIGS. 9 and 10 show the states where a commenter “KANSUKE YAMAMOTO” inputs his comments. Though the commenter can be selected with a name selection button B21 of pull-down menu type in the commenter input field of the new comment region RE5, this is not an indispensable manner and the commenter may be inputted each time.

Further, the discussion thread screen W2 is provided with an attribute selection button B23 for specifying approval or disapproval on the theme by using a pull-down menu in making a comment in the new comment region RE5b and this selection of approval or disapproval is required in making a comment. The attribute specified here serves as a simple indication of the standpoint of the commenter on the theme and is also used as an index for the statistical operation in the output operation discussed later. By using the attribute, it is possible to easily sort out and sum up the contents of the thread.

When the user of the client computer C inputs the necessary items and selects an application button B22, the inputted contents are sent to the server computer 1 as new comment data DN2 (Step S31-c).

In the server computer 1, the receiving portion 20, receiving this data, gives an operation request to the comment addition portion 62. The comment addition portion 62 gives the new comment data DN2 to the comment database DB2 corresponding to the category specified on the thread. In the comment database DB2, a new record based on the new comment data DN2 is generated and stored therein. In other words, the contents of the items on the new comment are added to the comment database DB2 (Step S31-s).

Such addition means an update of the content of the comment data D3, and then the thread display portion 61, in response to this, puts the theme data D2 and the comment data D3 after addition in the thread form F3 and sends the composite form to the client computer C again (Step S32-s). The client computer C displays the received contents (Step S32-c), to thereby achieve the display of the thread screen W where the newly-made comment is added to the comment display region RE4, i.e., the display of the thread where the detail of the comment is updated (Step S32).

<Attribute Change>

In the present preferred embodiment, in the discussion thread screen W2, an attribute change where the attribute given to a comment which has been already made is changed can be performed. This is performed by the action of the attribute change portion 63. Specifically, a selection button B24 for selecting one of different alternatives with a pull-down menu is attached to each comment displayed in the comment display region RE4 and the attribute change can be performed by using the selection button B24. It is preferable, however, that only the client computer C having the administrator authority (the client computer C which the administrator uses) should be allowed to perform this attribute change. Such a limitation may be realized, for example, by identifying the client computer C having the administrator authority with an access ID which is used in accessing the electronic bulletin board or requiring the input of password to check if the client computer C has the administrator authority in actually performing the attribute change.

The attribute change is performed for the purpose of suppressing divergence of the detail of the comment in the thread when the administer judges that the detail of the comment in the thread does not conform to the attribute attached in making the comment. Specifically, this applies to a case where if a comment having the attribute of disapproval on the theme is judged to be only a reference opinion from the flow of discussion, the attribute “DISAPPROVAL” provided to the comment by the commenter is changed to the attribute “REFERENCE”. This makes it possible to more appropriately sort out the contents of the thread and sum them up.

The attribute change portion 63 also performs an operation for changing the attribute of the thread itself. Specifically, the operation of changing the status of the thread (displayed in the item 16 of the main menu MM) from “INCOMPLETE” to “COMPLETE” or from “COMPLETE” to “INCOMPLETE” is performed by the action of the attribute change portion 63. The status of “INCOMPLETE” indicates a condition where comments on the thread will be accepted and the status of “COMPLETE” indicates a condition where comments on the thread will not be accepted.

When the theme is proposed, the status is “INCOMPLETE”. If a complete button B26 is selected, however, the status is changed to “COMPLETE” and comments after that time are forbidden. Specifically, the information that such a selection is made is given to the server computer 1 and the status of the thread is rewritten from “INCOMPLETE” to “COMPLETE” in the bulletin board database DB1. Further, after that, the application button B22 is changed to a resume button. When this resume button is selected, making a new comment is permitted again. It is preferable that selection of the complete button B26 should be performed only by the client computer C having the administrator authority.

<Conclusion Edit>

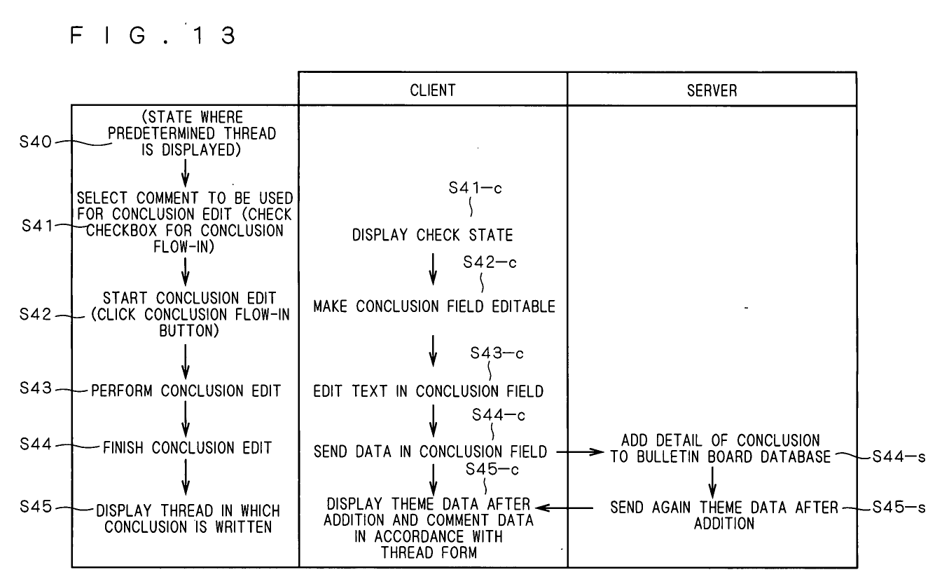

Next, an operation for generating a conclusion on a theme, specifically, an operation for editing the details of the comments as appropriate to obtain a conclusion will be discussed. FIG. 13 is a view showing an operation flow on conclusion edit. Such an operation is performed by the action of the conclusion edit portion 64. It is preferable that the conclusion edit operation should be also performed only by the client computer C having the administrator authority, in terms of the nature of the operation.

In a state where a thread on a theme is displayed on the browser B (Step S40), if the thread screen W as shown in FIG. 9 or 10, for example, is displayed, a checkbox C1 of “CONCLUSION FLOW-IN” is attached to each comment displayed in the comment display region RE4 and a check can be turned on or off by the client computer C. This is because the description to implement the function relevant to the thread form F3 has been made in advance.

For the conclusion edit, first, as a preparation therefor, it is necessary to put a check in the checkbox C1 of “CONCLUSION FLOW-IN” on some of the comments, whose details should be used for generation of conclusion (Step S41). In a state where there are checks in the checkboxes C1 as appropriate (Step S41-c), when a conclusion flow-in button B25 is selected (Step S42), the text of the comment with its checkbox C1 checked is flowed into a conclusion field RE3c of the theme region RE3 and the field becomes editable (Step S42-c)

When the conclusion field becomes editable, the user performs a text edit by addition, deletion or correction of the text data as appropriate (Step S43-c), to thereby achieve the conclusion edit (Step S43). This makes it possible to efficiently sum up the conclusion based on the details of the comments.

In finishing the conclusion edit (Step S44), when the conclusion flow-in button B25 is selected again, the text information present in the conclusion field RE3c at that time is sent, along with the identification number of the theme, as the conclusion data D4 to the server computer 1 from the client computer C (Step S44-c). The receiving portion 20, receiving the conclusion data D4, gives an operation request to the conclusion edit portion 64. The conclusion edit portion 64 gives the conclusion data D4 to the bulletin board database DB1 and adds the contents to the record with the corresponding identification number (Step S44-s).

Such addition means an update of the content of the theme data D2, and then the thread display portion 61, in response to this, puts the theme data D2 after addition and the comment data D3 in the thread form F3 and sends the composite form to the client computer C again (Step S45-s). The client computer C displays the received contents (Step S45-c), to thereby achieve the display of the thread screen W where the conclusion is written into the conclusion field RE3c (Step S45).

The conclusion edit is not necessarily performed after the complete button B26 is selected but it may be performed at the point of time when several comments are made, on the basis of these comments. In this case, the operation is the summary of comments in an intermediate stage rather than the conclusion edit. The thread screens W of FIGS. 9 and 10 each show a situation where such a summary edit of comments is performed and after that, the comment is made by the commenter “KANSUKE YAMAMOTO”.

Also in a case where the conclusion flow-in button B25 is selected with no check put in the checkboxes, since the conclusion field RE3c which is still blank becomes editable, it is possible to perform an input of text as appropriate and display the conclusion like the above case.

<Output Operation>

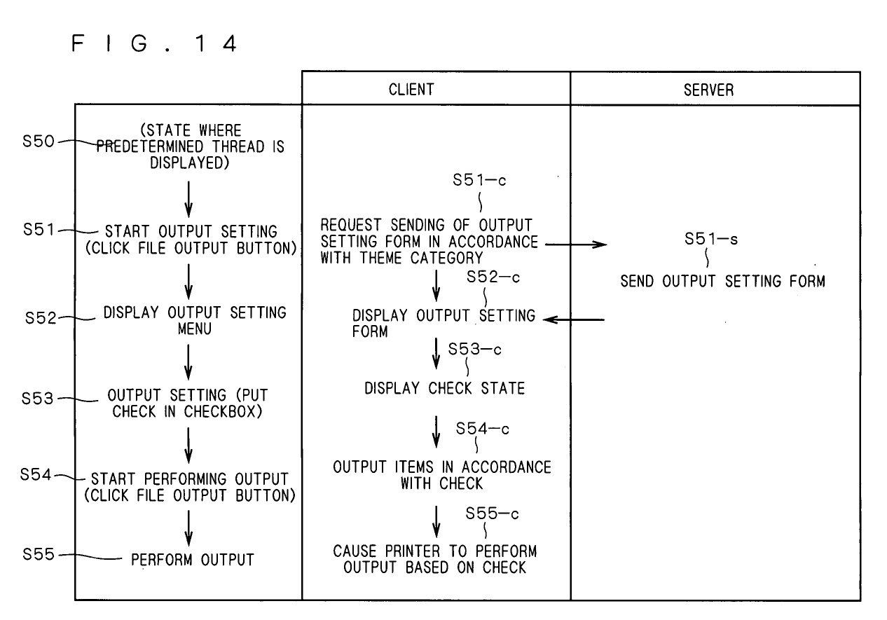

Next, an operation for outputting the contents of the thread displayed on the browser B by using the printer P will be discussed. FIG. 14 is a view showing an operation flow on output. Such an operation is performed by the action of the output portion 70.

In a state where the thread screen W shown in FIG. 9 or 10 is displayed, i.e., where a thread on a theme is displayed on the browser B (Step S50), if a check is put into a checkbox C2 on the comment to be outputted and a file output button B27 is selected, as a preparation of output operation, setting of necessary output conditions (output setting) is started (Step S51). In response to the selection of the file output button B27, the client computer C sends the URL of the output setting form F4 to provide an output setting menu corresponding to the category of the thread to the server computer 1 (Step S51-c). This corresponds to a sending request for the output setting form F4 (Step S51-c).

In the server computer 1, the receiving portion 20, receiving the URL, interprets the URL as one relevant to output setting and gives a request for an operation of output setting to the output portion 70. The output portion 70 responds to this request and reads any one output setting form F4 (F4a, F4b . . . ) corresponding to the category of the thread out from the memory portion 12. The output setting form F4 is sent to the client computer C by the sending portion 30 (Step S51-s) and the client computer C displays the received contents (Step S52-c), to thereby achieve the display of the output setting menu MO in accordance with the category of the thread in the client computer C (Step S52).

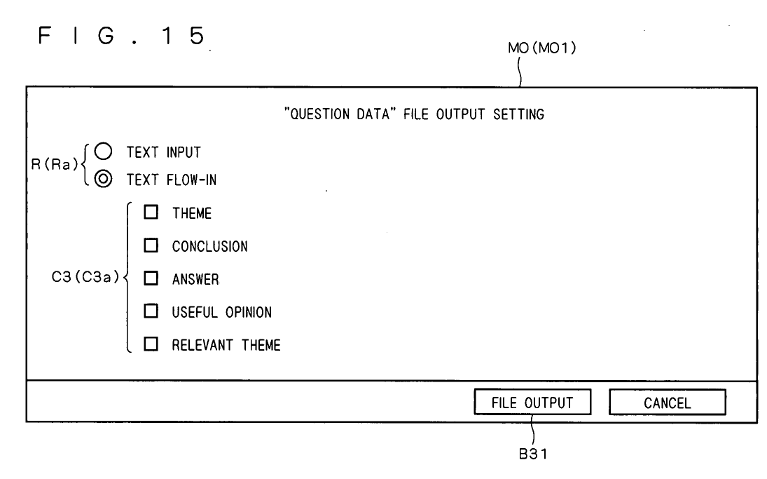

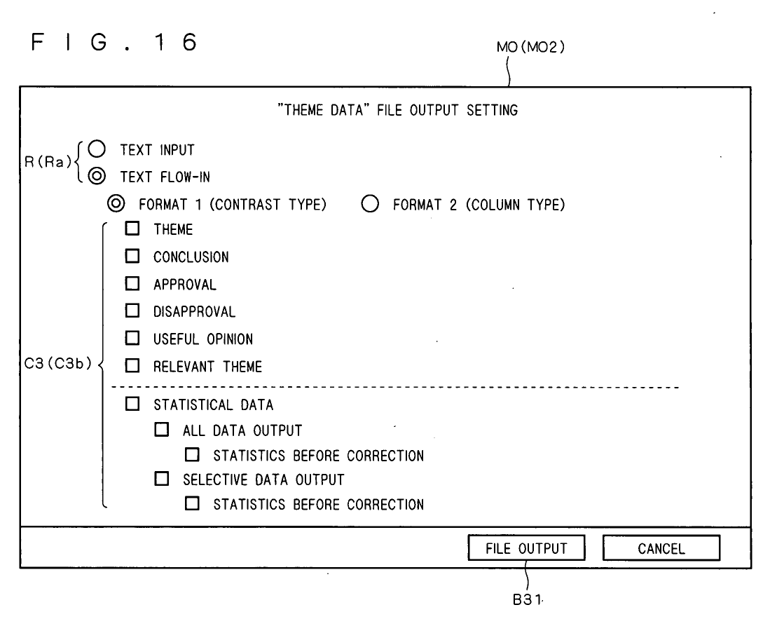

For example, FIG. 15 is a view showing an exemplary question output setting menu MO1 which is an output setting menu MO on the theme of “Question” category. FIG. 16 is a view showing an exemplary discussion output setting menu MO2 which is an output setting menu MO on the theme of “Discussion” category. The former has a layout in accordance with a comment output setting form F4a and the latter has a layout in accordance with a comment output setting form F4b. There is a difference in setting items between these output setting forms, and this is because there is a difference in output contents regarded as important depending on the categories and the output of contents of the thread in an effective manner is intended on each category.

In any one case, when the output setting menu is displayed, it is possible to perform an output setting by making a selection with the radio button R (Ra or Rb) as appropriate or putting a check into a checkbox C3 (C3a or C3b) (Step S53). In a state where the setting is made as appropriate and the checks are displayed (Step S53-c), if a file output button B31 is selected (Step S54), the checked items become ones to be outputted (Step S54-c) and the output operation is performed (Step S55). Specifically, the client computer C sends an instruction for performing a print operation on the basis of the checked items to the printer P connected thereto, and the printer P responds to this instruction to perform a print operation (Step 55-c).

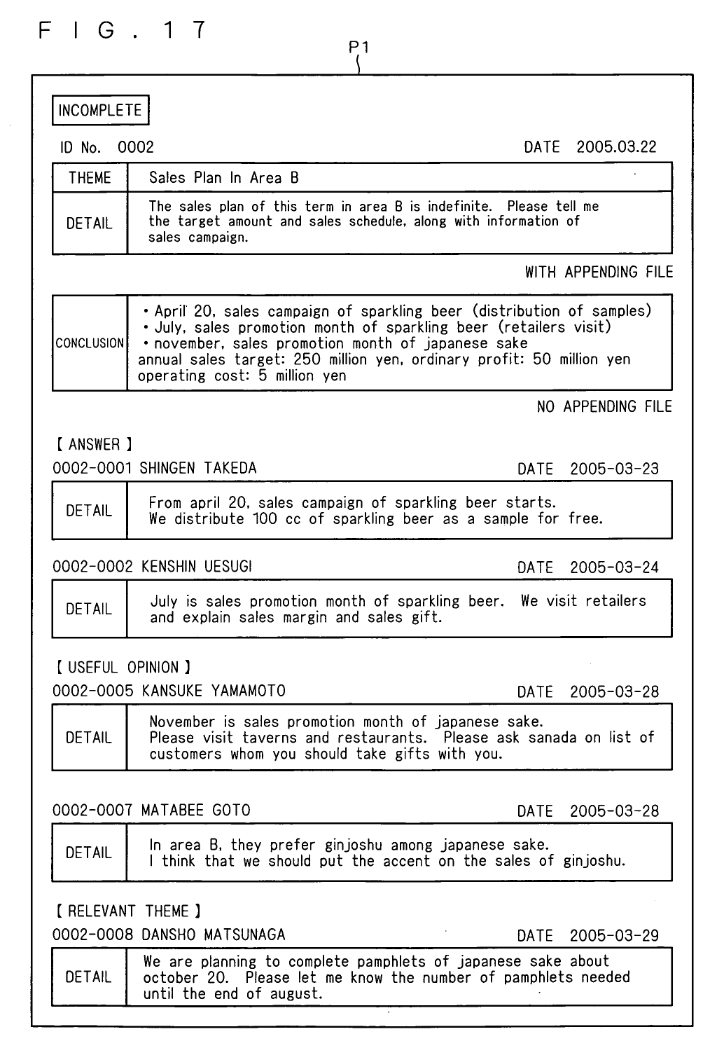

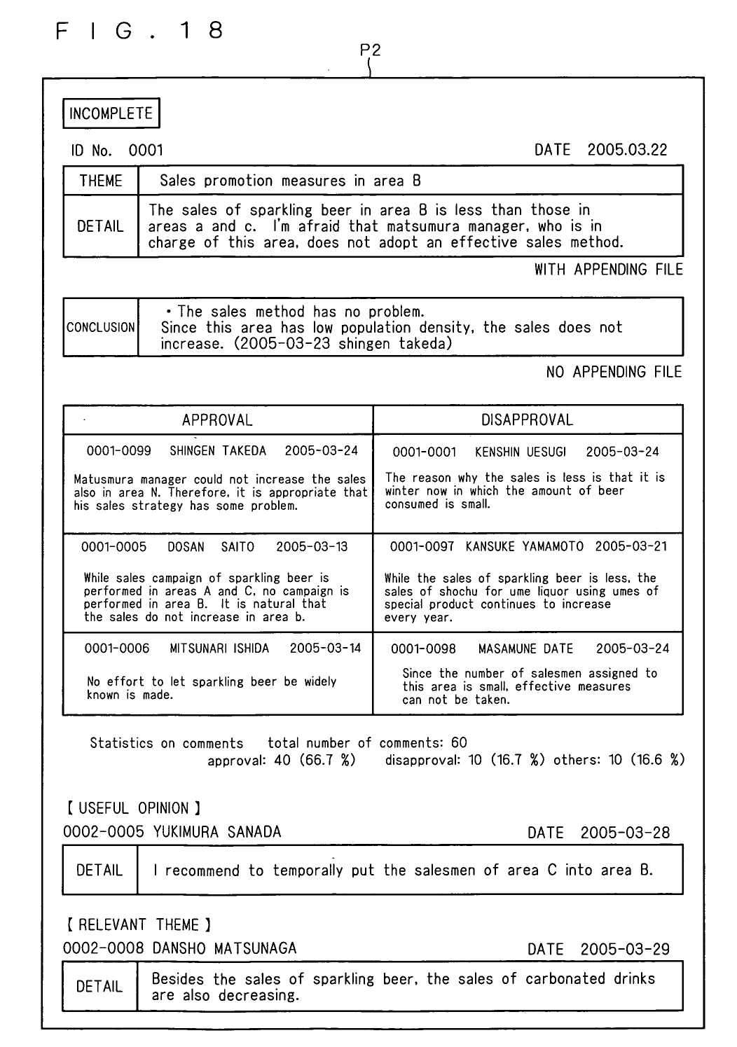

FIG. 17 is a view showing an exemplary output result P1 on the thread of “Question” category. FIG. 18 is a view showing an exemplary output result P2 on the thread of “Discussion” category. As can be seen at first glance, the output forms of FIGS. 17 and 18 are different from each other. This is because the contents which can be set in these output setting menus MO corresponding to these output results are different from each other.

Specifically, in the output result P1 of the “Question” category, the items of theme, conclusion, answer, useful opinion and relevant theme are arranged in series. In other words, the items are arranged in order of importance on the theme.

In contrast to this, in the output result P2 of the “Discussion” category, next to the theme and the conclusion, the comments from the standpoint (attribute) of approval and those from the standpoint (attribute) of disapproval are juxtaposed. Further, the statistical result based on the attributes of the comments is shown below that.

In terms of the nature of the comments required in the “Discussion” category, there are some cases where such a contrastive arrangement is effective if necessary. In the bulletin board system 10 of the present preferred embodiment, since the output pattern can be set by using the discussion output setting menu MO2, it is possible to easily perform an output with such a layout. In other words, it is possible to efficiently perform an output proper for the theme.

To present the statistical result, out of the records stored in the comment database DB2, those which have a check in the pertinent checkbox C3b are counted by the action of the output portion 70 when the file output button B31 is selected in the output setting menu MO and the client computer C acquires the counted result (total number).

Thus, in the bulletin board system of the present preferred embodiment, when a new theme is proposed and a thread is created in the electronic bulletin board, a category applicable to the thread is specified and the theme and the category are displayed together in the main menu, and the thread is displayed in a form in accordance with the specified category. With this operation, by specifying the category in accordance with the theme proposed in the thread, it is possible to suppress the divergence of comment details made on the thread in advance and limit the direction of comments. Further, on the thread, it becomes easy to display the contents proper for the nature of the proposed theme and efficiently perform an output display. This allows more efficient decision making and information sharing by using the bulletin board system.

Furthermore, since the comment details made on the thread can be summed up and sorted out, it is possible to efficiently sum the conclusion on the theme.

In addition, in making a comment on the theme proposed in the thread, the standpoint of the commenter on the theme can be concisely expressed by an attribute and if the comment detail does not conform to the attached attribute, the attribute can be changed. This makes it possible to appropriately sort out and sum up the contents of the thread. If the statistical operation on the comments is performed, the attribute can be used as an index for the operation.

While the invention has been shown and described in detail, the foregoing description is in all aspects illustrative and not restrictive. It is therefore understood that numerous modifications and variations can be devised without departing from the scope of the invention.

What is claimed is:

1. A bulletin board system, comprising:
a) a server computer; and
b) at least one client computer provided, being capable of accessing said server computer through a network,
where said server computer comprises
a-1) a thread creation element for providing a predetermined thread creation menu to said at least one client computer to create a thread in response to a creation request based on said thread creation menu;
a-2) a category specification element for providing a predetermined category specification menu to said at least one client computer to specify one out of a plurality of predetermined categories on the thread created by said thread creation element in response to a predetermined specification request based on said category specification menu;
a-3) a comment operation element for enabling a comment from said at least one client computer on a comment object thread in response to a predetermined comment request from said client computer;
a-4) a storage element for storing a detail of the thread created by said thread creation element and a detail of the comment on the thread which is given by said at least one client computer, along with information of a category specified on the thread, in a predetermined database;
a-5) a form memory element for storing a plurality of display forms corresponding to a plurality of categories which can be specified by said category specification element; and
a-6) a display element for acquiring a display form of a display object thread from said form memory element in response to a predetermined display request from said at least one client computer and putting a display detail of said display object thread acquired from said database into said display form, thereby implementing of displaying said display object thread in said client computer,
wherein said comment object thread is selected out of one or more threads created in said thread creation element, by a client computer which makes said comment request,
said display object thread is selected out of one or more threads created in said thread creation element, by a client computer which makes said display request, and
the acquisition of said display form in said display element is performed on the basis of a category specified by said category specification element on said display object thread.

2. The bulletin board system according to claim 1, wherein
said form memory element stores a plurality of output condition setting forms corresponding to categories which can be specified in said category specification element,
said server computer further comprises
a-7) an output element for acquiring an output condition setting form of an output object thread from said form memory element in response to an output request from said at least one client computer, thereby making said client computer perform an output condition setting for said output object thread,
said output object thread is selected out of one or more threads created in said thread creation element, by a client computer which makes said output request, and
the acquisition of said output condition setting form in said output element is performed on the basis of a category specified by said category specification element on said output object thread.

3. The bulletin board system according to claim 1, wherein
said server computer further comprises
a-8) a conclusion edit element for enabling a conclusion edit on a thread being displayed in response to a conclusion edit request from one of said at least one client computer,
said thread being displayed is at least one thread created in said thread creation element, which is displayed by one of said at least one client computer, and
at least one comment detail included in the thread is selected to be edited in said conclusion edit.

4. The bulletin board system according to claim 1, wherein
said comment operation element comprises
a-3-1) an attribute giving element operating to allow said at least one client computer to give an attribute to a comment when said comment is made from said at least one client computer.

5. The bulletin board system according to claim 4, wherein
said server computer further comprises
a-9) an attribute change element for enabling a change of an attribute of a comment displayed in said thread being displayed in response to an attribute change request from said at least one client computer, and
said thread being displayed is one thread out of at least one thread created in said thread creation element, which is displayed in one of said at least one client computer.

6. A server computer of a bulletin board system, which at least one client computer can access through a network, comprising:
a thread creation element for providing a predetermined thread creation menu to said at least one client computer to create a thread in response to a creation request based on said thread creation menu;
a category specification element for providing a predetermined category specification menu to said at least one client computer to specify one out of a plurality of predetermined categories on the thread created by said thread creation element in response to a predetermined specification request based on said category specification menu;
a comment operation element for enabling a comment from said at least one client computer on a comment object thread in response to a predetermined comment request from said client computer;
a storage element for storing a detail of the thread created by said thread creation element and a detail of the comment on the thread which is given by said at least one client computer, along with information of a category specified on the thread, in a predetermined database;
a form memory element for storing a plurality of display forms corresponding to a plurality of categories which can be specified by said category specification element; and
a display element for acquiring a display form of a display object thread from said form memory element in response to a predetermined display request from said at least one client computer and putting a display detail of said display object thread acquired from said database into said display form, thereby implementing of displaying said display object thread in said client computer,
wherein said comment object thread is selected out of one or more threads created in said thread creation element, by a client computer which makes said comment request,
said display object thread is selected out of one or more threads created in said thread creation element, by a client computer which makes said display request, and
the acquisition of said display form in said display element is performed on the basis of a category specified by said category specification element on said display object thread.

7. The server computer of a bulletin board system according to claim 6, wherein
said form memory element stores a plurality of output condition setting forms corresponding to categories which can be specified in said category specification element,
said server computer further comprising
an output element for acquiring an output condition setting form of an output object thread from said form memory element in response to an output request from said at least one client computer, thereby making said client computer perform an output condition setting for said output object thread,
wherein said output object thread is selected out of one or more threads created in said thread creation element, by a client computer which makes said output request, and
the acquisition of said output condition setting form in said output element is performed on the basis of a category specified by said category specification element on said output object thread.

8. The server computer of a bulletin board system according to claim 6, further comprising
a conclusion edit element for enabling a conclusion edit on a thread being displayed in response to a conclusion edit request from one of said at least one client computer,
wherein said thread being displayed is at least one thread created in said thread creation element, which is displayed by one of said at least one client computer, and
at least one comment detail included in the thread is selected to be edited in said conclusion edit.

9. The server computer of a bulletin board system according to claim 6, wherein
said comment operation element comprises
an attribute giving element operating to allow said at least one client computer to give an attribute to a comment when said comment is made from said at least one client computer.

10. The server computer of a bulletin board system according to claim 9, further comprising
an attribute change element for enabling a change of an attribute of a comment displayed in said thread being displayed in response to an attribute change request from said at least one client computer, and
said thread being displayed is one thread out of at least one thread created in said thread creation element, which is displayed in one of said at least one client computer.

11. A method of displaying a thread in a client computer of a bulletin board system, comprising the steps of:
a) providing a bulletin board system comprising a server computer and at least one client computer being capable of accessing said server computer through a network;
b) making creation of a thread by said server computer based on a request through one or each of said at least one client computer in accordance with a predetermined thread creation menu provided by said server computer;
c) executing specification of a category on said thread created in said step b) through said one or each of said at least one client computer in accordance with a predetermined category specification menu provided by said server computer;
d) storing a detail of said thread created in said step b), along with information of said category specified on said thread in said step c), into a predetermined database by a predetermined storage processing element included in said server computer;
e) executing an instruction for display about a display object thread to said server computer through any one of said at least one client computer;
f) making acquisition of a display form by said server computer from a predetermined memory element in response to said display instruction from the client computer performing said step e), said display form corresponding to a category specified on said display object thread, and said predetermined memory element storing a plurality of display forms corresponding to categories specifiable in said step c);
g) making acquisition of a detail of said display object thread from said database by said server computer;
h) putting a detail of said display object thread into said display form by a predetermined composing element included in said server computer; and
i) displaying said display object thread on the client computer performing said step e) on the basis of a composite result in said step h).

12. A program stored in a computer, said program being executed in said computer to cause said computer to function as a server computer of a bulletin board system, which is accessible to at least one client computer through a network,
wherein said server computer comprises
a thread creation element for providing a predetermined thread creation menu to said at least one client computer to create a thread in response to a creation request based on said thread creation menu;
a category specification element for providing a predetermined category specification menu to said at least one client computer to specify one out of a plurality of predetermined categories on the thread created by said thread creation element in response to a predetermined specification request based on said category specification menu;
a comment operation element for enabling a comment from said at least one client computer on a comment object thread in response to a predetermined comment request from said client computer;
a storage element for storing a detail of the thread created by said thread creation element and a detail of the comment on the thread which is given by said at least one client computer, along with information of a category specified on the thread, in a predetermined database;
a form memory element for storing a plurality of display forms corresponding to a plurality of categories which can be specified by said category specification element; and a display element for acquiring a display form of a display object thread from said form memory element in response to a predetermined display request from said at least one client computer and putting a display detail of said display object thread acquired from said database into said display form, thereby implementing of displaying said display object thread in said client computer,
wherein said comment object thread is selected out of one or more threads created in said thread creation element, by a client computer which makes said comment request,
said display object thread is selected out of one or more threads created in said thread creation element, by a client computer which makes said display request, and
the acquisition of said display form in said display element is performed on the basis of a category specified by said category specification element on said display object thread.
